(19) United States
(12) Patent Application Publication
(10) Pub. No.: US 2010/0178517 A1
(43) Pub. Date: Jul. 15, 2010

(54) METHOD FOR OBTAINING A FIBROUS MATERIAL/SILICONE COMPOSITE, AND SAID FIBROUS MATERIAL/SILICONE COMPOSITE

(75) Inventors: Alain Pouchelon, Meyzieu (FR); Francis Lafaysse, Lyon (FR)

Correspondence Address: PEARNE & GORDON LLP, 1801 EAST 9TH STREET, SUITE 1200, CLEVELAND, OH, 44114-3108, US

(73) Assignee: BLUESTAR SILICONES FRANCE, Lyon, FR (FR)

(21) Appl. No.: 12/593,960

(22) PCT Filed: Apr. 3, 2008
(86) PCT No.: PCT/EP2008/054039

§ 371 Date: Mar. 23, 2010

(30) Foreign Application Priority Data
Apr. 3, 2007 (FR) 07/54245

(51) Int. Cl. B32B 17/02; B05D 1/00; B32B 9/04

(52) U.S. Cl. 428/429; 427/209; 428/447

(57) ABSTRACT

A method for obtaining a cross-linked fibrous material/silicone elastomer composite and the composite for textile architecture. The method avoids capillary ascension, preserves cohesion of the coated textile, and limits delamination between different silicone layers. The method comprises, in order: 1) coating one face of the textile substrate with a first liquid, silicone composition cross-linkable into an elastomer with a dynamic viscosity before cross-linking of between 5000 and 200000 mPa·s at 25° C.; 2) cross-linking the first liquid silicone composition; 3) coating the other face with a second liquid, silicone composition cross-linkable into an elastomer, said second silicone composition having a dynamic viscosity before cross-linking lower than or equal to 2000 mPa·s at 25° C. for textile core impregnation, and having after cross-linking a number of reactive groups for adhesion of an optional composition subsequently applied onto the second silicone composition; 4) cross-linking the second silicone composition impregnating the textile substrate.

The invention relates to a method for obtaining a fibrous material/cross-linked silicone elastomer composite and said fibrous material/cross-linked silicone composite.

This type of composite can be used more particularly in the field of textile architecture, in which composites are used comprising a fibrous support, such as a polymer or glass fabric, coated on each of its surfaces with a silicone elastomer coating, which may itself be coated with a layer of varnish.

In a standard fashion, the treatment of fibrous materials (in particular of the flexible supports such as woven supports or non-woven supports), using liquid silicone compositions which can be cross-linked into elastomers, is carried out by coating and most often by impregnation, when the compositions are emulsions or solutions.

Silicone coating is defined as the action of coating a fibrous support, in particular a textile, using a liquid silicone composition which can be cross-linked, then cross-linking the film coated onto the support, in order to produce a coating intended in particular to protect it, to confer particular qualities upon it, for example to give it hydrophobic/oleophobic and impermeable characteristics or improved mechanical properties or also suitable for modifying the appearance thereof.

Impregnation is defined as the action of causing a very fluid cross-linkable silicone-based liquid to penetrate inside a fibrous support (core penetration) then causing the silicone to cross-link in order to confer the above-mentioned type of properties upon the support.

In practice, silicone elastomer coatings on textile supports have numerous advantages linked to the intrinsic characteristics of the silicones. These composites have in particular good flexibility, good mechanical strength and improved burning behaviour.

Moreover, unlike conventional elastomers, the silicones confer upon them, among other things, appropriate protection due to their water repellency and their excellent resistance to chemical, thermal and climatic attack as well as great longevity.

These properties ensure that the silicone elastomers are particularly effective in the field of textile architecture, in which the textile-polymer composites are subject to a vast number of restrictive specifications covering both the mechanical characteristics of the composite and its resistance to the various external attacks and its durability. For example, the water-repellent character of the silicones is favourable to the water-proofing properties and to the protection of the fibres of the textile core of the composite, in order to avoid the problems of capillary rise in the textile core of the composite.

However, the method of deposition of the silicones by coating may have shortcomings. In fact, the architectural tissues exposed to the elements should not exhibit capillary rise effect from the edges, which would be detrimental to their aesthetic appearance and to their service life. Coating as it is carried out does not represent an effective technique for protecting fibrous materials vis-à-vis the phenomenon of capillary rise. In fact, the threads of the textile must be particularly well coated in order to be protected.

To remedy this, it has been proposed to resort to the technique of core impregnation of fibrous materials, by means of fluid liquid silicone compositions, such as that described in the European Patent Application EP 1 525 277, of RTV-2 type which can be cross-linked into an elastomer.

Nevertheless, the use of this fluid composition requires a stage of core impregnation, an elementary operation which is sometimes difficult and involves a method with associated equipment which forces the impregnation inside the fibres of the textile support, such as padding.

The limitations relating to the fluidity of the impregnation product are the mechanical properties which it develops when it is cross-linked. In fact, with respect to the chemistry of cross-linking of elastomers, the mechanical properties achieved are generally in relation to the molar mass of the precursor polymers in the composition, i.e. their viscosity; low viscosities (low molar masses) do not allow significant mechanical characteristics such as high elongation and good tear strength. This results in a limitation which involves resorting to other processes such as dilution with solvents; this latter process itself being limited on the deposition machinery for environmental and safety reasons.

Moreover the impregnation method is detrimental to the cohesion of the impregnated textile on leaving the machine section where the fluid impregnation elastomer is applied. This can result in distortions in the fabric which are detrimental to the quality of the finished article.

The inventors have therefore sought to develop a novel method for obtaining a fibrous material/cross-linked silicone elastomer composite offering an alternative to known methods for solving the problem of capillary rise in composites intended more particularly for textile architecture.

Another essential objective of the present invention is to propose a method for obtaining a composite which preserves the cohesion of the coated fibrous material in order not to impair the quality of the final product.

Another essential objective the present invention is to propose a method for obtaining a fibrous material/silicone composite which limits the risks of delamination and which guarantees good adhesion between the different silicone layers.

These objectives, among others, are achieved by the present invention which relates firstly to a method for obtaining a fibrous material/cross-linked silicone elastomer composite characterized in that it comprises at least the following main stages, carried out in the order indicated:
1) coating one of the surfaces of a fibrous support using a first liquid silicone composition, which can be cross-linked into an elastomer, and having a dynamic viscosity before cross-linking comprised between 5,000 and 200,000 mPa·s at 25° C.;
2) cross-linking the first liquid silicone composition coated on the fibrous support;
3) coating the other surface of the fibrous support using a second liquid silicone composition, which can be cross-linked into an elastomer, said second composition silicone
   having a dynamic viscosity before cross-linking less than or equal to 2,000 mPa·s at 25° C., preferably less than or equal to 1,500 mPa·s, and still more preferentially less than or equal to 1,000 mPa·s, in order to penetrate into the fibres of the fibrous support,
   and having after cross-linking a sufficient number of residual reactive groups to allow the adhesion of an optional composition subsequently coated onto the second silicone composition;
4) cross-linking the second liquid silicone composition which has penetrated into the fibres of the fibrous support.

In the present disclosure, the viscosities indicated correspond to a level of dynamic viscosity measured at 25° C., using a BROOKFIELD viscosimeter, according to the AFNOR standard NFT 76 106 of May 1982.

According to the method of the invention, the second composition is very fluid and its applied to the surface of a fibrous support the other surface of which is already coated with a silicone elastomer, obtained from a more viscous composition. This first, already coated, surface provides the fibrous support with good cohesion, so that the application of the second, very fluid, composition is greatly facilitated: there are no deformations due to the softening of the fibrous support resulting from its being wetted to the core by the very fluid composition.

Furthermore, the first, already coated, surface constitutes an impermeable layer which prevents the second, very fluid, composition from flowing through the fibrous support.

Moreover, according to the sequence of the coating and cross-linking stages of the invention, the first and second silicone compositions are applied respectively to each of the surfaces of the fibrous support. The first and second silicone compositions are therefore each mechanically anchored in the fibrous support, such that the risks of delamination between the different applied layers are limited.

According to a preferred method for the implementation of the method according to the invention, at least one additional coating and cross-linking stage 5) is provided, carried out after stage 4).

In a particularly preferred manner, the additional coating and cross-linking stage 5) involves coating the surface coated in stage 3) and cross-linked in stage 4) with a third liquid silicone composition, which can be cross-linked into an elastomer and having a dynamic viscosity before cross-linking comprised between 5,000 and 200,000 mPa·s at 25° C.; and cross-linking said coated composition.

This third silicone composition can be identical to or different from the first silicone composition.

A treatment combining at least one silicone coating of each of the surfaces of the fibrous support with a viscous silicone composition and at least one coating with a more fluid silicone composition, which penetrates into the fibres, according to the method of the invention, ensures the quality of the fibrous material the properties of which it is sought to modify, in particular the resistance to capillary rises, without prejudice to the other mechanical properties, water-repellent finish, fire resistance and appearance.

The use of other products such as a layer of varnish, may also be provided depending on the sought properties.

The general techniques for coating fibrous supports are well known to a person skilled in the art: doctor blade, in particular a doctor blade on a roll, a floating knife, and doctor blade on a belt, lick roller, “reverse roll”, transfer, spraying.

Preferably, the coating of stages 1, 3 and 5 is carried out using a doctor blade.

After each coating, drying and cross-linking are carried out, preferably by hot air or infrared, for example between 30 s and 5 min, at a cross-linking temperature not exceeding the decomposition temperature of the fibrous support, for example a temperature comprised between 50 and 200° C.

The liquid silicone compositions used in the present invention can be compositions which can be cross-linked by addition, condensation, dehydrogenocondensation, radicular or UV reaction, or mixed systems combining these different types of reaction.

Preferably, the liquid silicone compositions used in the present invention, and more particularly those coated in stages 1 and 3 are compositions which can be cross-linked by polyaddition (hydrosilylation), in particular of the two-component type (known as RTV-2), and comprise:
(A) at least one polyorganosiloxane (POS) with ≡Si-alkenyl (preferably ≡Si-vinyl) units;
(B) at least one polyorganosiloxane (POS) with ≡Si—H units;
(C) a catalytically effective quantity of at least one catalyst, preferably comprising at least one metal belonging to the platinum group
(D) optionally at least one adhesion promoter;
(E) optionally at least one mineral filler;
(F) optionally at least one cross-linking inhibitor; and
(G) optionally functional additives in order to impart specific properties.

In the present disclosure, reference is made to the following “silicone” nomenclature in order to represent the siloxy units (“Chemistry and technology of silicones” Walter NOLL Academic Press 1968 Table 1 page 3″):
M: (R^{o})₃SiO_{1/2},
M^{Alk}: (R^{o})₂(Alk)SiO_{1/2},
D: (R^{o})₂SiO_{2/2},
D^{Alk}: (R^{o})(Alk)SiO_{2/2},
M′: (R^{o})₂(H)SiO_{1/2},
D′: (R^{o})(H)SiO_{2/2},
M^{OH}: (R^{o})₂(OH)SiO_{1/2},
D^{OH}: (R^{o})(OH)SiO_{2/2},
T: (R^{o})SiO_{3/2},
Q: SiO_{4/2},
where R^{o} is chosen from the linear or branched alkyl groups having 1 to 8 carbon atoms inclusive (e.g. methyl, ethyl, isopropyl, tert-butyl and n-hexyl), optionally substituted by at least one halogen atom (e.g. trifluoro-3,3,3 propyl), as well as from the aryl groups (e.g. phenyl, xylyl and tolyl),
Alk=alkenyl, preferably vinyl (denoted Vi), or allyl.

The polyorganosiloxane POS (A) preferably has units of formula:

WₐZ_{b}SiO_{(4-(a+b))/2} (A.1)

in which:
W is an alkenyl group, preferably a C₂-C₆ alkenyl; and still more preferentially a vinyl,
Z is a monovalent hydrocarbon group, with no unfavourable effect on the activity of the catalyst and chosen from the alkyl groups having 1 to 8 carbon atoms inclusive, optionally substituted by at least one halogen atom, as well as from the aryl groups,
a is 1 or 2, b is 0, 1 or 2 and a+b is equal to 1, 2 or 3;
   and optionally other units of average formula:

Z_{c}SiO_{(4-c)/2} (A.2)
in which Z has the same meaning as above and c is 0, 1, 2 or 3;

The Z groups can be identical or different.

By “alkenyl”, is meant a substituted or non-substituted, linear or branched, unsaturated hydrocarbon chain, having at least one olefin double bond, and more preferably a single double bond. Preferably, the “alkenyl” group has 2 to 8 carbon atoms, better still 2 to 6. This hydrocarbon chain optionally comprises at least one heteroatom such as O, N, S.

Preferred examples of “alkenyl” groups are the vinyl, allyl and homoallyl groups; vinyl being particularly preferred.

By “alkyl”, is meant a linear or branched, cyclic, saturated hydrocarbon chain, optionally substituted (e.g. by one or more alkyls), preferably with 1 to 10 carbon atoms, for example with 1 to 8 carbon atoms, better still with 1 to 4 carbon atoms.

Examples of alkyl groups are in particular methyl, ethyl, isopropyl, n-propyl, tert-butyl, isobutyl, n-butyl, n-pentyl, isoamyl and 1,1-dimethylpropyl.

The expression “aryl” designates an aromatic hydrocarbon group, having 6 to 18 carbon atoms, which is monocyclic or polycyclic and preferably monocyclic or bicyclic. It must be understood that, within the framework of the invention, by polycyclic aromatic radical, is meant a radical having two or more aromatic nuclei, condensed (orthocondensed or ortho and pericondensed) with each other, i.e. having, in pairs, at least two carbon atoms in common.

As an example of “aryl”, there can be mentioned e.g. the phenyl, xylyl and tolyl radicals.

Of course, according to the variants, the POS (A) can be a mixture of several oils corresponding to the same definition as the POS (A).

The POS (A) can be formed solely by units of formula (A. 1) or can also contain units of formula (A.2).

According to a variant, the POS (A) can be a linear polymer, the diorganopolysiloxane chain of which is essentially constituted by siloxy units D or D^{Vi}, and is blocked at each end by a siloxy unit M or M^{Vi}. Such a POS (A) can be present in one of the liquid silicone compositions used in the invention, for example the first and optionally the third silicone compositions.

Preferably, at least 60% of the Z groups represent methyl radicals. The presence, along the diorganopolysiloxane chain, of small quantities of units other than Z₂SiO, for example units of formula ZsiO_{1.5} (T siloxy units) and/or SiO₂ (Q siloxy units) is not however excluded in the proportion of at most 2% (these percentages expressing the number of the T and/or Q units per 100 atoms of silicon).

Examples of siloxyl units of formula (A.1) are the vinyldimethylsiloxyl, vinylphenylmethylsiloxyl, vinylmethylsiloxyl and vinylsiloxyl units.

Examples of siloxyl units of formula (A.2) are the SiO_{4/2}, dimethylsiloxyl, methylphenylsiloxyl, diphenylsiloxyl, methylsiloxyl and phenylsiloxyl unit.

Examples of POS (A) are the dimethylpolysiloxanes with dimethylvinylsilyl ends, the methylvinyldimethylpolysiloxane copolymers with trimethylsilyl ends, the methylvinyldimethylpolysiloxane copolymers with dimethylvinylsilyl ends and the cyclic methylvinylpolysiloxanes.

According to another variant, the POS (A) can be a polyorganosiloxane resin. Such a POS (A) can be present in one of the liquid silicone compositions used in the invention, for example the second silicone composition.

This polyorganosiloxane resin comprises at least one alkenyl radical in its structure and has a content by weight of alkenyl radical group(s) comprised between 0.1 and 20% by weight and, preferably, between 0.2 and 10% by weight.

These resins are well-known branched organopolysiloxane oligomers or polymers which are commercially available. They are preferably presented in the form of siloxane solutions. They comprise, in their structure, at least two different units chosen from the M, D, T and Q units, at least one of these units being a T or Q unit.

The R radicals are identical or different and are chosen from the linear or branched C₁-C₆ alkyl radicals, the C₂-C₄ alkenyl, phenyl and 3,3,3 trifluoropropyl radicals. There can for example be mentioned: as alkyl radicals R, the methyl, ethyl, isopropyl, tert-butyl and n-hexyl radicals, and such as alkenyl radicals R, the vinyl radicals.

It must be understood that in the resins of the abovementioned type, some of the R radicals are alkenyl radicals.

As examples of branched organopolysiloxane oligomers or polymers, there can be mentioned the MQ resins, the MDQ resins, the TD resins and the MDT resins, the alkenyl functions being able to be carried by the M, D and/or T units. As examples of resins which are particularly suitable, there can be mentioned the vinylated MDQ or MQ resins having a content by weight of vinyl groups comprised between 0.2 and 10% by weight, these vinyl groups being carried by the M and/or D units.

This structure resin is advantageously present in a concentration comprised between 10 and 70% by weight with respect to all of the constituents of a composition, preferably between 30 and 60% by weight and, still more preferentially, between 40 and 60% by weight.

The different POSs (A) used in the invention are marketed by the silicone manufacturers or can be manufactured by operating according to already known techniques.

POS (B) is cross-linking POS, and is preferably of the type of those comprising the siloxyl unit of formula:

H_{d}LₑSiO_{(4-(d+e))/2} (B.1)

in which:
L is a monovalent hydrocarbon group with no unfavourable effect on the activity of the catalyst and chosen from the alkyl groups having 1 to 8 carbon atoms inclusive, optionally substituted by at least one halogen atom, and also from the aryl groups,
d is 1 or 2, e is 0, 1 or 2 and d+e is equal to 1, 2 or 3; and optionally other siloxyl units of average formula:

L_{g}SiO_{(4-g)/2} (B.2)
in which L has the same meaning as above and g is 0, 1, 2 or 3.

The polyorganosiloxane (B) can be formed solely from units of formula (B.1) or additionally comprise units of formula (B.2).

The polyorganosiloxane (B) can have a linear, branched, cyclic or cross-linked structure.

The group L has the same meaning as the Z group above.

Examples of siloxyl units of formula (B.1) are:

H(CH₃)₂SiO_{1/2}, HCH₃SiO_{2/2}, H(C₆H₅)SiO_{2/2}.

The examples of siloxyl units of formula (B.2) are the same as those indicated above for the examples of siloxyl units of formula (A.2).

Examples of polyorganosiloxanes (B) are linear and cyclic compounds such as
the dimethylpolysiloxanes with hydrogenodimethylsilyl ends,
the copolymers with (dimethyl)-(hydrogenomethyl)-polysiloxane units with trimethylsilyl ends,
the copolymers with (dimethyl)-(hydrogenomethyl)-polysiloxane units with hydrogenodimethylsilyl ends,
the hydrogenomethylpolysiloxanes with trimethylsilyl ends,
the cyclic hydrogenomethylpolysiloxanes.

The POS (B) can optionally be a mixture of a dimethylpolysiloxane with hydrogenodimethylsilyl ends and a polyorganosiloxane carrying at least 3 SiH (hydrogenosiloxyl) functions.

The POSs (A) and (B) are chosen as a function of their viscosity and of the viscosity required for the first or second silicone composition.

Preferably, the proportions of the polyorganosiloxanes (A) and (B) in the first silicone composition, and optionally of the third composition, are such that the molar ratio of the number of the hydrogen atoms bound to the silicon in the polyorganosiloxane (B) to the number of alkenyl radicals bound to the silicon in the polyorganosiloxane (A) is comprised between 1 and 7.

The proportions of (A) and of (B) in the second silicone composition can be such that the molar ratio of the atoms of hydrogen bound to the silicon in (B) to the alkenyl radicals bound to the silicon in (A) is comprised between 0.5 and 7.

As regards the second silicone composition more specifically, the latter is preferably rich in reactive groups such that the number of reactive groups remaining after cross-linking is sufficient to allow the adhesion of any subsequent coating composition. For this purpose, the proportions of (A) and of (B) in the second silicone composition can be such that the molar ratio of the hydrogen atoms bound to the silicon in (B) to the alkenyl radicals bound to the silicon in (A) is less than 1 and the ≡Si-alkenyl (preferably ≡Si-Vinyl) units content in said second composition is greater than or equal to at least 2% in number, preferably greater than or equal to at least 3%, and, still more preferentially comprised between 2 and 10% in number, the ≡Si-alkenyl (preferably ≡Si-Vinyl) units being advantageously essentially carried by D siloxyl units: —R₂SiO_{2/2}—. In order to do this, the second composition can comprise at least one hyperalkenylated (preferably hypervinylated) POS (A), rich in ≡Si-alkenyl units according to the characteristics indicated above.

According to other variants, in order to have a sufficient number of reactive groups after cross-linking, it is also possible to provide in stage 4) an incomplete cross-linking of the second silicone composition by providing a sub-dosage of cross-linking POS (B). The second silicone composition can also comprise two different cross-linking systems (for example thermal and UV), a single mechanism being activated at the time of the cross-linking of the second layer of silicone.

Moreover, the second silicone composition also has the particular feature of being capable of penetrating well into the fibres of a fibrous material, so as to coat them well, then cross-linking so as to form a composite having a capillary rise of less than 20 mm, preferably less than 10 mm and still more preferentially equal to 0, the capillary rise being measured according to a test T.

The polyaddition reaction specific to the cross-linking mechanism of the composition used in the invention is well known to a person skilled in the art. A catalyst (C) can also be used in this reaction. This catalyst (C) can in particular be chosen from the platinum and rhodium compounds. The complexes of platinum and an organic product described in U.S. Pat. No. 3,159,601, U.S. Pat. No. 3,159,602, U.S. Pat. No. 3,220,972 and the European patents EP-A-0 057 459, EP-A-0 188 978 and EP-A-0 190 530, the platinum and vinylated organosiloxane complexes described in U.S. Pat. No. 3,419,593, U.S. Pat. No. 3,715,334, U.S. Pat. No. 3,377,432 and U.S. Pat. No. 3,814,730 can in particular be used. The generally preferred catalyst is platinum. In this case, the quantity by weight of catalyst (C), calculated by weight of platinum-metal, is generally comprised between 2 and 400 ppm, preferably between 5 and 100 ppm based on the total weight of the POSs (A) & (B).

Preferably, the adhesion promoter (D) comprises:
(d.1) at least one alkoxylated organosilane corresponding to the following general formula:

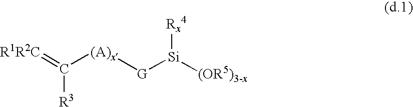

in which:
R¹, R², R³ are hydrogenated or hydrocarbon radicals which are identical to or different from each other and representing hydrogen, a linear or branched C₁-C₄ alkyl or a phenyl optionally substituted by at least one C₁-C₃ alkyl;
A is a linear or branched C₁-C₄ alkylene;
G is a valency bond or oxygen;
R⁴ and R⁵ are identical or different radicals and represent a linear or branched C₁-C₄ alkyl;
   x′ is 0 or 1
   x=0 to 2;
said compound (d.1) preferably being vinyltrimethoxysilane (VTMS);
(d.2) at least one organosilicate compound comprising at least one epoxy radical, said compound (d.2) preferably being 3-Glycidoxypropyltrimethoxysilane (GLYMO);
(d.3) at least one chelate of metal M and/or a metal alkoxide of general formula M(OJ)ₙ, with n=valency of M and J=linear or branched C₁-C₈ alkyl, M being chosen from the group formed by: Ti, Zr, Ge, Li, Mn, Fe, Al, Mg,
   said compound (d.3) preferably being tert-butyl titanate.

The proportions of (d.1), (d.2) and (d.3), expressed in % by weight with respect to the total of the three, are preferably as follows:
(d.1)≧10,
(d.2)≧10,
(d.3)≦80.

Moreover, this adhesion promoter (D) is preferably present at a level of 0.1 to 10%, preferably 0.5 to 5% and still more preferably 1 to 2.5% by weight with respect to all of the constituents of the first, second or third silicone composition.

It is also possible to provide a filler (E) which is preferably mineral. It can be constituted by products chosen from siliceous (or non-siliceous) materials.

With regard to the siliceous materials, they can act as reinforcing or semi-reinforcing fillers.

The reinforcing siliceous fillers are chosen from the colloidal silicas, the fumed and precipitated silica powders or mixtures thereof.

These powders have a mean particle size generally less than 0.1 μm and a BET surface area greater than 50 m²/g, preferably comprised between 100 and 300 m²/g.

Semi-reinforcing siliceous fillers such as diatomaceous earths or ground quartz can also be used.

As regards the non-siliceous mineral materials, they can act as semi-reinforcing mineral filler or bulking filler. Examples of these non-siliceous fillers which can be used alone or in mixture are carbon black, titanium dioxide, aluminium oxide, hydrated alumina, expanded vermiculite, zirconia, a zirconate, unexpanded vermiculite, calcium carbonate, zinc oxide, mica, talc, iron oxide, barium sulphate and slaked lime. These fillers have a particle size generally comprised between 0.01 and 300 μm and a BET surface area of less than 100 m²/g.

In a practical but non-limitative manner, the filler used is a silica.

The filler can be treated using any appropriate compatibilizer and in particular hexamethyldisilazane. For more details in this regard, reference can be made for example to the patent FR-B-2 764 894.

As regards weight, it is preferable to utilize a quantity of filler comprised between 5 and 30, preferably between 7 and 20% by weight with respect to all of the constituents of the composition.

The cross-linking inhibitors (F) are also well known. They are in a standard fashion chosen from the following compounds:
polyorganosiloxanes, advantageously cyclic and substituted by at least one alkenyl, tetramethylvinyltetrasiloxane being particularly preferred,
pyridine,
organic phosphines and phosphites,
unsaturated amides,
alkylated maleates,
and acetylenic alcohols.
   These acetylenic alcohols, (cf. FR-B-1 528 464 and FR-A-2 372 874), which are among the preferred thermal blockers of the hydrosilylation reaction, have the formula:

R—(R′)C(OH)—C≡CH

a formula in which:
R is a linear or branched alkyl radical, or a phenyl radical;
R′ is H or a linear or branched alkyl radical, or a phenyl radical;
the R, R′ radicals and the carbon atom situated in α position of the triple bond optionally being able to form a ring;
the total number of carbon atoms contained in R and R′ being at least 5, preferably 9 to 20.
   Said alcohols are, preferably, chosen from those having a boiling point above 250° C. There can be mentioned as examples:
1-ethynyl-1-cyclohexanol;
3-methyl-1-dodecyn-3-ol;
3,7,11-trimethyl-1-dodecyn-3-ol;
1,1-diphenyl-2-propyn-1-ol;
3-ethyl-6-ethyl-1-nonyn-3-ol;
3-methyl-1-pentadecyn-3-ol.
   These alpha-acetylenic alcohols are commercially available products.
   Such an inhibitor (F) is present at a level of 3,000 ppm maximum, preferably at a level of 100 to 2 ppm with respect to the total weight of the organopolysiloxanes (A) and (B).

As regards the functional additives (G) which can be utilized, these can be covering products such as for example pigments/dyes, stabilizers or additives for improving fire resistance.

The viscosity of the different silicone compositions used in the present invention can be adjusted in order to reach the values required by modifying the quantities of the constituents and by choosing in particular polyorganosiloxanes (A) and (B) of suitable viscosities. The compositions used in the present invention can be without solvent and obtained from constituents of appropriate viscosity. The compositions can also be diluted in order to reach the viscosities required before cross-linking for each coating stage according to the invention.

More particularly, the second silicone composition can be without solvent or obtained by dilution or solubilization in a solvent such that the second liquid silicone composition in the diluted state before cross-linking has a viscosity less than or equal to 2,000 mPa·s. The solvent can be a reactive solvent, such as an alpha olefin for example.

For reasons of storage, the silicone compositions used in the invention are advantageously presented in the form of an at least two-component system the mixture of which is capable of cross-linking rapidly when hot by polyaddition. The ingredients are then divided into the different parts according to the rules known to a person skilled in the art; in particular the catalyst is separated from the component which comprises the hydrogen siloxanes.

The fibrous support intended to be coated can be for example a fabric, a nonwoven or knitted material or more generally any fibrous support comprising fibres chosen from the group of materials comprising: glass, silica, metals, ceramic, silicone carbide, carbon, boron, basalt, natural fibres such as cotton, wool, hemp, linen, artificial fibres such as viscose, or cellulosic fibres, synthetic fibres such as the polyesters, polyamides, polyacrylics, chlorofibres, polyolefins, synthetic rubbers, polyvinyl alcohol, aramids, fluorofibres, phenolics etc.

According to another of its aspects, the invention relates to a fibrous material/cross-linked silicone elastomer composite comprising at least one fibrous support, as defined above, one surface of which is coated at least with a first cross-linked silicone elastomer obtained from a first liquid silicone composition, as defined above, and the other surface of which is coated at least with a second cross-linked silicone elastomer, which penetrates into the fibres of the support, and obtained from a second liquid silicone composition, as defined above.

Preferably, said surface coated at least with a second silicone elastomer which penetrates into the fibres of the support, is itself coated with a third cross-linked silicone elastomer, obtained from a third liquid silicone composition, as defined above.

Such a composite is characterized by a capillary rise of less than 20 mm, preferably of less than 10 mm and still more preferentially equal to 0, the capillary rise being measured according to a test T.

The composite according to the invention can be used more particularly as an architectural textile. By “architectural textile”, is meant a woven or nonwoven fabric and more generally any fibrous support intended, after coating, for making:
shelters, movable structures, textile buildings, partitions, flexible doors, tarpaulins, tents, stands or marquees;
furniture, claddings, billboards, windshields or filter panels;
solar protection panels, ceilings and blinds.

The fibrous material/cross-linked silicone elastomer composites according to the invention can also be used as flexible raw materials for making air bags used for protecting the occupants of a vehicle, glass braids (woven glass sheaths for thermal and dielectric protection for electrical wires), conveyor belts, fire-barrier or thermal insulation fabrics, compensators (flexible sealing sleeves for pipe work), clothing etc.

The following examples are intended to illustrate particular embodiments of the invention without limiting the latter to these particular simple embodiments.

### Description of the Tests

### Capillary Rise Tests

The capillary rise is given by the height to which liquid with which the end of a composite strip is brought into contact, according to a T test, rises.

The T test is carried out as follows:
a strip measuring 2×20 cm of the textile/silicone composite is cut,
a tank is prepared containing a coloured ink (for example fountain pen ink),
the cut-out composite strip is suspended vertically above the ink container so as to make the strip flush with the ink,
the 0 level is defined as the meniscus line of the ink on the strip,
the composite strip is left in place until the rising front of the ink is in equilibrium,
the height (H) in millimetres corresponding to the difference between the level 0 and the maximum rise level of the ink along the strip is measured.

The capillary rise is defined by the distance H.

A sample is well protected from the phenomenon if the rises are virtually zero.

This property is recorded as ‘Yes’ if the rises are at most of the order of 1 cm and ‘No’ if they exceed this reading.

### Delamination Test

In order to judge the good adhesion of the first and second coated elastomer layers to each other, an assembly of the corresponding composites is prepared by gluing with a silicone elastomer rubber RHODORSIL MF 345 L®, marketed by Bluestar Silicones, which is a ready-to-use silicone rubber.

In order to do this, the elastomer adhesive is placed between two sheets of composite in order to obtain, after vulcanization, an adhesive joint 5 cm wide by approximately 0.5 mm thick.

The vulcanization is carried out under a press at 180° C. for 2 min.

Test pieces 50 mm in width are cut out of the prepared composite boards. These test pieces are evaluated using a dynamometer in a peeling experiment at 50 mm/min carried out in so-called 180° geometry.

The site of the break is noted during the peeling measurement. If it takes place between the first and the second coated layers with a low resistance (typically <1 daN/cm), a ‘delamination’ is reported which can be prejudicial to the behaviour of the assembly. In the contrary case, the result ‘Yes’ is recorded.

### EXAMPLES

In all the examples which follow, a glass fabric prepared with threads of approximately 10 μm, with an areal weight of approximately 250 g/m² is used as a fibrous support.

For the coating of each composition using a doctor blade, a Mathis coating machine is used. This is a system comprising
a device for holding the fibrous support to be coated
a height-adjustable doctor blade
a temperature-controlled oven

### Example 1

### Example 1.1

### Invention

In this example, the composite of the invention comprises a fibrous support, one surface of which is coated with a first cross-linked silicone elastomer obtained from a first liquid silicone composition, and the other surface of which is coated with a second cross-linked silicone elastomer, which penetrates into the fibres of the support and obtained from a second liquid silicone composition.

A silicone elastomer RHODORSIL TCS 7534® marketed by Bluestar Silicones, a self-adhesive elastomer vulcanizable by polyaddition, presented in two-component form, is used as first and second liquid silicone composition. 10 parts of B are combined with 100 parts of A.

For the first silicone composition, undiluted TCS 7534® A+B is used. The viscosity of the first silicone composition is 45 Pa·s.

For the second silicone composition, TCS 7534® A+B diluted with 30 parts of xylene per 100 parts of elastomer is used. The viscosity of the second silicone composition is 1.5 Pa·s

According to the method of the invention, one surface of the glass fabric is coated, using a doctor blade, with the first silicone composition, aiming at a deposited weight of 200 g/m². After deposition, the first silicone composition is cross-linked at 150° C. for 2 min.

Then, using a doctor blade, the other surface of the glass fabric is coated with the second silicone composition. After deposition, the second silicone composition is cross-linked at 150° for 2 min. The resulting deposit is of the order of 100 g/m².

The composite obtained is subjected to different tests. The results are given in Table I below:

### Example 1.2

### Comparative

By way of comparison, a composite is prepared according to the examples described in the Patent Application EP 1 525 277.

To this end, the composition TCS 7534® A+B diluted with 30 parts of xylene per 100 parts of elastomer is firstly deposited on the glass fabric by impregnation by calendering. To do this, a laboratory calender is used equipped with 2 rolls with a diameter of 100 mm and a length of 250 mm. One roll is made of steel, the other of rubber.

The impregnation bath is simultaneously supplied to the fabric to be impregnated, in the gap between the cylinders.

The cylinders are placed under pressure one on top of the other and the speed of rotation is approximately 2 m/min.

The composition is cross-linked. Then, using a doctor blade one of the surfaces of the fabric is coated with the undiluted composition TCS 7534® A+B by means of a Mathis coating machine. The composition is cross-linked.

The composite obtained is subjected to different tests. The results are given in Table I below:

### Example 1.3

### Comparative

By way of comparison, a composite is prepared by reversing the stages of the method according to the invention, i.e. by beginning with stages 3) and 4, followed by stages 1) and 2).

In order to do this, using a doctor blade, one of the surfaces of the fabric is coated with the composition TCS 7534® A+B diluted with 30 parts of xylene per 100 parts of elastomer by means of a Mathis coating machine. The composition is cross-linked. Then, using a doctor blade, the other surface of the fabric is coated with the undiluted composition TCS 7534® A+B. The composition is cross-linked.

The composite obtained is subjected to different tests. The results are given in Table I below:

### Example 1.4

### Comparative

By way of comparison, using a doctor blade, a composite is prepared by coating only one of the surfaces of the fabric with the undiluted composition TCS 7534(R) A+B by means of a Mathis coating machine. Then the composition is cross-linked.

The composite obtained is subjected to different tests. The results are given in Table I below:

### Results

TABLE I

| | | Delamination | Capillary |
|---|---|---|---|
| Example: | Observations | Test | rise tests |
| Example 1.1 | Good stability of the | yes | yes |
| (inv.) | fabric | | |
| Example 1.2 | Deformation of the | Delamination | yes |
| (comp.) | fabric | | |
| Example 1.3 | Deformation of the | Delamination | yes |
| (comp.) | fabric | | |
| Example 1.4 | NA | yes | no |
| (comp.) | | | |

The application by coating of the second, more fluid, silicone composition is greatly facilitated by the good cohesion of the fabric provided by the elastomer deposited by surface coating with the first, more viscous, silicone composition. There are no longer any deformations due to the softening of the fabric resulting from its being wetted to the core by the second, more fluid, silicone composition to be applied.

Furthermore, the elastomer obtained from the first silicone composition forms an impermeable layer which prevents the second, more fluid, silicone composition from passing through the fabric.

Moreover the recommended sequence limits the risks of delamination between the various applied layers because each of them has the possibility of mechanical anchoring to the fibrous support.

Finally, the capillary rises are eliminated thanks to the fluidity of the second silicone composition which will penetrate well into the fibres of the fabric.

### Example 2

### Example 2.1

### Invention

In this example, the composite of the invention comprises a fibrous support, one surface of which is coated with a first cross-linked silicone elastomer obtained from a first liquid silicone composition, and the other surface of which is first coated with a second cross-linked silicone elastomer, which penetrates into the fibres of the support, and obtained from a second liquid silicone composition, then coated with a third cross-linked silicone elastomer obtained from a third liquid silicone composition.

The undiluted silicone elastomer RHODORSIL TCS 7534® A+B (viscosity of 45 Pa·s), as described in Example 1, is used as first and third liquid silicone composition.

The second, more fluid, liquid silicone composition is a silicone composition of siloxane resin, which comprises:
100 parts of the resin SILCOLEASE RCA 12®, marketed by Bluestar Silicones,
1 part of an adhesion promoter COATOSIL 1770®, marketed by GE-Silicones,
1.5 part of cross-linking agent SILCOLEASE CROSS-LINKER 96A®, marketed by Bluestar Silicones,
1.5 part of catalyst SILCOLEASE CATALYSEUR 12070®, marketed by Bluestar Silicones.

This second liquid silicone composition has a viscosity of 1 Pa·s.

The quantity of cross-linking agent is such that the cross-linking reaction is incomplete.

Thus, the second silicone composition has, after cross-linking, a number of reactive groups sufficient to allow the adhesion of the third silicone composition subsequently applied as a coating.

One of the surfaces of the glass fabric is firstly coated with the first silicone composition using a doctor blade, by means of a Mathis coating machine. The deposited weight is 200 g/m². After deposition, the first silicone composition is cross-linked at 150° C. for 2 min.

The other surface of the fabric is coated with the second silicone composition using a doctor blade, by means of a Mathis coating machine.

After deposition, the second silicone composition is cross-linked at 130° C. for 1 min. The resulting deposit is of the order of 50 g/m².

Then, using a doctor blade, a third silicone layer is applied to the second cross-linked silicone composition by coating by means of a Mathis coating machine. The deposited weight is 200 g/m². After deposition, the third silicone composition is cross-linked at 150° C. for 2 min.

The composite obtained is subjected to different tests. The results are given in Table II below:

### Example 2.2

### Comparative

By way of comparison, Example 2.1 is reproduced, but using for the second, more fluid, silicone layer, 5 parts of cross-linking agent SILCOLEASE CROSS-LINKER 96A®. As there is an excess of cross-linking agent, the second silicone composition is completely cross-linked and no longer has any reactive group available to allow the adhesion of the third silicone layer applied subsequently.

The composite obtained is subjected to different tests. The results are given in Table II below:

### Results

TABLE II

| | | Delamination | Capillary |
|---|---|---|---|
| Example: | Observations | Test | rise test |
| Example 2.1 | Good stability of the | yes | yes |
| (inv.) | fabric | | |
| Example 2.2 | Good stability of the | Delamination | yes |
| (comp.) | fabric | | |

The application of the second, more fluid, silicone composition is, as previously, greatly facilitated by the recommended method.

The capillary rises are eliminated thanks to the fluidity of this second silicone composition which penetrates well into the fibres of the fabric.

A delamination is observed when the second silicone composition is completely cross-linked. On the other hand, when a sub-dose of cross-linking agent is used, the incomplete cross-linking leaves enough reactive groups for a good anchoring of the subsequent coating layer.

1. Method for obtaining a fibrous material/cross-linked silicone elastomer composite comprising at least the following main stages, carried out in the order indicated:
1) coating one of the surfaces of a fibrous support using a first liquid silicone composition, which can be cross-linked into an elastomer, and having a dynamic viscosity before cross-linking comprised between 5,000 and 200,000 mPa·s at 25° C.;
2) cross-linking the first liquid silicone composition coated on the fibrous support;
3) coating the other surface of the fibrous support using a second liquid silicone composition, which can be cross-linked into an elastomer, said second silicone composition
having a dynamic viscosity before cross-linking less than or equal to 2,000 mPa·s at 25° C., preferably less than or equal to 1,500 mPa·s, and still more preferentially less than or equal to 1,000 mPa·s, in order to penetrate into the fibres of the fibrous support,
and having after cross-linking a sufficient number of residual reactive groups to allow the adhesion of an optional composition subsequently coated onto the second silicone composition;
4) cross-linking the second liquid silicone composition which has penetrated into the fibres of the fibrous support.

2. Method according to claim 1, comprising at least one additional coating and cross-linking stage 5), carried out after stage 4).

3. Method according to claim 2, wherein the additional coating and cross-linking stage 5) consists of coating the surface coated in stage 3) and cross-linked in stage 4) with a third liquid silicone composition, which can be cross-linked into an elastomer and having a dynamic viscosity before cross-linking comprised between 5,000 and 200,000 mPa·s at 25° C.; and cross-linking said coated composition.

4. Method according to claim 1, wherein the coating of stages 1, 3 and 5 is carried out using a doctor blade.

5. Method according to claim 1, wherein the liquid silicone compositions coated in stages 1 and 3 are compositions which are which can be cross-linked by polyaddition and comprise:
(A) at least one polyorganosiloxane (POS) with ≡Si-alkenyl (preferably ≡Si-vinyl) units;
(B) at least one polyorganosiloxane (POS) with ≡Si—H units;
(C) a catalytically effective quantity of at least one catalyst, preferably comprising at least one metal belonging to the platinum group;
(D) optionally at least one adhesion promoter;
(E) optionally at least one mineral filler;
(F) optionally at least one cross-linking inhibitor;
(G) optionally functional additives in order to impart specific properties.

6. Method according to claim 5, wherein the chosen polyorganosiloxane (A) has units of formula:
WₐZ_{b}SiO_{(4-(a+b))/2} (A.1)
in which:
W is an alkenyl group, preferably a C₂-C₆ alkenyl; and still more preferentially a vinyl,
Z is a monovalent hydrocarbon group, with no unfavourable effect on the activity of the catalyst and chosen from the alkyl groups having 1 to 8 carbon atoms inclusive, optionally substituted by at least one halogen atom, as well as from the aryl groups,
a is 1 or 2, b is 0, 1 or 2 and a+b is equal to 1, 2 or 3;
and optionally other units of average formula:
Z_{c}SiO_{(4-c)/2} (A.2)
in which Z has the same meaning as above and c is 0, 1, 2 or 3.

7. Method according to claim 5, wherein the polyorganosiloxane (B) comprises siloxyl units of formula:
H_{d}LₑSiO_{(4-(d+e))/2} (B.1)
in which:
L is a monovalent hydrocarbon group with no unfavourable effect on the activity of the catalyst and chosen from the alkyl groups having 1 to 8 carbon atoms inclusive, optionally substituted by at least one halogen atom, and also from the aryl groups,
d is 1 or 2, e is 0, 1 or 2 and d+e is equal to 1, 2 or 3;
and optionally other units of average formula:
L_{g}SiO_{(4-g)/2} (B.2)
in which L has the same meaning as above and g is 0, 1, 2 or 3.

8. Method according to claim 5, wherein the adhesion promoter (D) comprises:
(d.1) at least one alkoxylated organosilane corresponding to the following general formula: 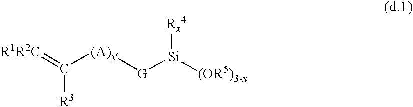
in which:
R¹, R², R³ are hydrogenated or hydrocarbon radicals which are identical to or different from each other and representing hydrogen, a linear or branched C₁-C₄ alkyl or a phenyl optionally substituted by at least one C₁-C₃ alkyl;
A is a linear or branched C₁-C₄ alkylene
G is a valency bond or oxygen;
R⁴ and R⁵ are identical or different radicals and represent a linear or branched C₁-C₄ alkyl;
x′ is 0 or 1;
x=0 to 2;
said compound (d.1) preferably being vinyltrimethoxysilane (VTMS);
(d.2) at least one organosilicate compound comprising at least one epoxy radical, said compound (d.2) preferably being 3-Glycidoxypropyltrimethoxysilane (GLYMO);
(d.3) at least one chelate of metal M and/or a metal alkoxide of general formula M(OJ)ₙ, with n=valency of M and J=linear or branched C₁-C₈ alkyl, M being chosen from the group formed by: Ti, Zr, Ge, Li, Mn, Fe, Al, Mg,
said compound (d.3) preferably being tert-butyl titanate.

9. Method according to claim 5, wherein the adhesion promoter is present at a level of 0.1 to 10% by weight with respect to all of the constituents of the first or second silicone composition.

10. Method according to claim 5, wherein the proportions of (A) and (B) in the first silicone composition are such that the molar ratio of the hydrogen atoms bound to the silicon in (B) to the alkenyl radicals bound to the silicon in (A) is comprised between 1 and 7.

11. Method according to claim 5, wherein the proportions of (A) and (B) in the second silicone composition are such that the molar ratio of the hydrogen atoms bound to the silicon in (B) to the alkenyl radicals bound to the silicon in (A) is comprised between 0.5 and 7.

12. Method according to claim 5, wherein the second silicone composition is obtained by dilution or solubilization in a solvent.

13. Method according to claim 5, wherein the proportions of (A) and of (B) in the second silicone composition can be such that the molar ratio of the hydrogen atoms bound to the silicon in (B) to the alkenyl radicals bound to the silicon in (A) is less than 1 and in that the ≡Si-alkenyl (preferably ≡Si-Vinyl) units content in said second composition is greater than or equal to at least 2% in number, preferably greater than or equal to at least 3%, and, still more preferentially comprised between 2 and 10% in number, the ≡Si-alkenyl (preferably ≡Si-Vinyl) units being advantageously essentially carried by D siloxyl units: —R₂SiO_{2/2}—.

14. Method according to claim 1, wherein the fibrous support comprises fibres chosen from the group of materials comprising glass, silica, metals, ceramic, silicone carbide, carbon, boron, basalt, natural fibres such as cotton, wool, hemp, linen, artificial fibres such as viscose, or cellulosic fibres, synthetic fibres such as the polyesters, polyamides, polyacrylics, chlorofibres, polyolefins, synthetic rubbers, polyvinyl alcohol, aramids, fluorofibres, phenolics.

15. Fibrous material/cross-linked silicone elastomer composite, comprising at least one fibrous support, one surface of which is coated at least with a first cross-linked silicone elastomer obtained from a first liquid silicone composition, as defined in the method of claims 1 to 10, and the other surface of which is coated at least with a second cross-linked silicone elastomer, which penetrates into the fibres of the support, and obtained from a second liquid silicone composition, as defined above in the method of claims 1 to 13.

16. Composite according to claim 15, wherein the surface coated with at least one second elastomer silicone which penetrates into the fibres of the support is itself coated with a third cross-linked silicone elastomer.

17. Composite according to claim 15 wherein the fibrous support comprises fibres chosen from the group of materials comprising glass, silica, metals, ceramic, silicone carbide, carbon, boron, basalt, natural fibres such as cotton, wool, hemp, linen, artificial fibres such as viscose, or cellulosic fibres, synthetic fibres such as the polyesters, polyamides, polyacrylics, chlorofibres, polyolefins, synthetic rubbers, polyvinyl alcohol, aramids, fluorofibres, phenolics.
